(19) United States
(12) Patent Application Publication
(10) Pub. No.: US 2019/0041975 A1
(43) Pub. Date: Feb. 7, 2019

(54) MECHANISMS FOR CHEMICAL SENSE RESPONSE IN MIXED REALITY

(71) Applicant: Intel Corporation, Santa Clara, CA (US)

(72) Inventors: Glen J. Anderson, Beaverton, OR (US); Oleg Pogorelik, Lapid (IL); Tamara Gaidar, Haifa (IL)

(21) Appl. No.: 15/940,903

(22) Filed: Mar. 29, 2018

(51) Int. Cl. G06F 3/01; A23L 27/00

(52) U.S. Cl. CPC G06F 3/011; A23V 2002/00; A23L 27/88

(57) ABSTRACT

Apparatus, systems, or methods for mixed reality with chemical sense response are disclosed herein. In embodiments, an apparatus for a mixed reality computing with chemical sense response may include monitor logic and distribution logic. The monitor logic may collect data about a user's response to a first set of stimulations to represent an actual chemical sense response by the user with respect to the first set of stimulations. Based on the collected data, a variance between the actual chemical sense response by the user with respect to the first set of stimulations, and a desired chemical sense response for the user with respect to the first set of stimulations may be determined. The distribution logic, including circuitry, may deliver to the user a second set of stimulations. Other embodiments may also be described and claimed.

### FIELD

Embodiments of the present disclosure relate generally to the technical fields of mixed reality, including augmented reality and virtual reality, and more particularly to chemical sense response in mixed reality.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Mixed reality (MR) or hybrid reality, encompassing both augmented reality (AR) and virtual reality (VR), merges real and virtual worlds to produce new environments and visualizations where physical and digital objects co-exist and interact in real time. With the increasing use of computing devices, such as mobile computing devices, MR, VR, or AR is becoming increasingly popular for users with regard to various applications and processes. In addition to visual or audio effects, simulating taste, smell, or other chemical sense response may be useful in MR as well. However, improvements may be desired for current MR systems in simulating chemical sense responses.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example apparatus for mixed reality (MR) including monitor logic and distribution logic located on a head-mounted device (HMD), the monitor logic to collect data about a user's chemical sense response, and the distribution logic to deliver to the user a set of stimulations, in accordance with various embodiments.

FIG. 2 illustrates an example apparatus for MR with chemical sense response including various components such as distribution logic, monitor logic, analytic logic, and plan logic, in accordance with various embodiments.

FIG. 3 illustrates an example process for determining a second set of stimulations to be delivered to a user for chemical sense response based on data about the user's response to a first set of stimulations, in accordance with various embodiments.

FIG. 4 illustrates an example device suitable for use to practice various aspects of the present disclosure, in accordance with various embodiments.

FIG. 5 illustrates a storage medium having instructions for practicing methods described with references to FIGS. 1-4, in accordance with various embodiments.

### DETAILED DESCRIPTION

Mixed reality (MR) or hybrid reality, encompassing both augmented reality (AR) and virtual reality (VR), may mainly include visual or audio effects delivered to a user in merged real and virtual worlds. MR systems for delivering chemical sense responses, e.g., taste, smell, or other chemical sense responses, may post additional challenges to MR systems for visual or audio effects.

There may be many kinds of chemical sense responses, e.g., taste, smell. For example, various tastes may include sweetness, umami or savory taste, salty taste, sour taste, bitter taste, spicy taste, starch taste, fat taste, metallic taste, an astringency taste, or a combination of several taste qualities. For a user, a chemical sense response, e.g., taste or smell, may be activated when certain classes of chemicals contact specialized epithelial taste receptor cells in the tongue, palate, throat and, in some species, near the epiglottis and the upper esophagus. The various categories of taste stimuli detected at the periphery may be processed alone, or in combination, to stimulate the percepts associated with nutrients and toxins, to drive complex ingestion or rejection behaviors, and to initiate physiological processes.

A set of stimulations delivered to different users in different context may generate different chemical sense responses from the users. A user's response to a set of stimulations may be impacted by the user age, personal background such as culture background, or an environment of the user. In a MR system including chemical sense responses to a user, a set of stimulations may have a desired chemical sense response for the user with respect to the set of stimulations. However, in reality, there may be a variance between an actual chemical sense response and a desired chemical sense response by the user with respect to the set of stimulations. In order to achieve the desired chemical sense response for the user, embodiments herein may include continuous monitoring of the user's responses with respect to a set of stimulations and adjustment of the set of stimulations to achieve a same or updated desired chemical sense response for the user.

In embodiments, an apparatus for a mixed, augmented, or virtual reality computing with chemical sense response may include monitor logic and distribution logic coupled to the monitor logic. The monitor logic may collect data about a user's response to a first set of stimulations to represent an actual chemical sense response by the user with respect to the first set of stimulations. Based on the collected data, a variance between the actual chemical sense response by the user with respect to the first set of stimulations, and a desired chemical sense response for the user with respect to the first set of stimulations may be determined. The distribution logic, including circuitry, may deliver to the user a second set of stimulations, wherein the second set of stimulations may be determined based at least in part on the variance between the actual chemical sense response by the user with respect to the first set of stimulations, and the desired chemical sense response for the user with respect to the first set of stimulations.

In embodiments, one or more non-transitory computer-readable media may include instructions for mixed, augmented, or virtual reality computing with chemical sense response. In response to execution of the instructions by the computer device, the instructions may operate the computer device to determine a variance between an actual chemical sense response by a user with respect to a first set of stimulations, and a desired chemical sense response for the user with respect to the first set of stimulations, where the actual chemical sense response by the user may be represented by data about the user's response to the first set of stimulations. The first set of stimulations may include one or more of an electrical stimulation, a chemical stimulation, a visual stimulation, or an audio stimulation. Furthermore, the instructions may operate the computer device to determine, by a stimulation determination algorithm, based on a user profile, context data for an environment of the user, system data related to the first desired chemical sense response, or the data about the user's response to the first set of stimulations, a second set of stimulations intended to generate an updated desired chemical sense response for the user, where the second set of stimulations may include one or more of an electrical stimulation, a chemical stimulation, a visual stimulation, or an audio stimulation to be delivered to the user.

In embodiments, a method for operating an apparatus for mixed, augmented, or virtual reality with chemical sense response may include: delivering, by distribution logic, to a user a first set of stimulations intended to generate a first desired chemical sense response for the user; collecting, by monitor logic, data about the user's response to the first set of stimulations to represent an actual chemical sense response by the user with respect to the first set of stimulations. In addition, the method may include determining, by analytic logic, a variance between the actual chemical sense response by the user with respect to the first set of stimulations, and the first desired chemical sense response for the user with respect to the first set of stimulations; and determining, by plan logic, based on a stimulation determination algorithm, a user profile, context data for an environment of the user, system data related to the first desired chemical sense response, the data about the user's response to the first set of stimulations, or the variance, a second set of stimulations intended to generate a second desired chemical sense response for the user to be delivered to the user. In embodiments, the first set of stimulations or the second set of stimulations may include one or more of an electrical stimulation, a chemical stimulation, a visual stimulation, or an audio stimulation.

In the description to follow, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or evolved node B (eNB), next generation nodeB (gNB), base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications

As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

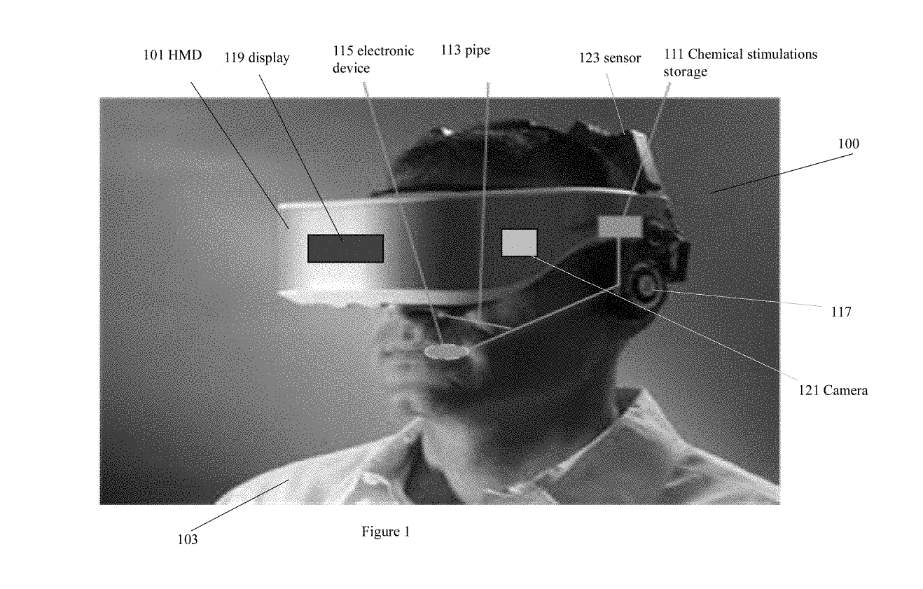

FIG. 1 illustrates an example apparatus 100 for MR including monitor logic and distribution logic located on a head-mounted device (HMD) 101, the monitor logic, e.g., a camera 121 or a sensor 123, to collect data about a user's response, and the distribution logic, e.g., a chemical stimulation storage 111, a pipe 113, an electronic device 115, an audio generator 117, or a display 119, to deliver to the user a set of stimulations, in accordance with various embodiments. For clarity, features of the apparatus 100, the distribution logic such as the chemical stimulation storage 111, the pipe 113, the electronic device 115, the audio generator 117, or the display 119, and the monitor logic such as the camera 121 or the sensor 123, and the HMD 101, may be described below as an example for understanding an apparatus for MR, distribution logic, or monitor logic. It is to be understood that there may be more or fewer components included in the apparatus 100, the monitor logic, and the distribution logic. Further, it is to be understood that one or more of the devices and components within the apparatus 100, the distribution logic such as the chemical stimulation storage 111, the pipe 113, the electronic device 115, the audio generator 117, or the display 119, and the monitor logic such as the camera 121 or the sensor 123, and the HMD 101 may include additional and/or varying features from the description below, and may include any devices and components that one having ordinary skill in the art would consider and/or refer to as an apparatus for MR, monitor logic, and distribution logic.

In embodiments, in a MR system, a set of stimulations may be delivered to a user 103 by the distribution logic, including circuitry, e.g., the chemical stimulation storage 111, the pipe 113, the electronic device 115, the audio generator 117, or the display 119, to generate a chemical sense response for the user 103. A set of stimulations may include one or more of a chemical stimulation stored in the chemical stimulation storage 111 and delivered by the pipe 113, an electrical stimulation delivered by the electronic device 115, an audio stimulation delivered by the audio generator 117, or a visual stimulation delivered by the display 119. For example, the electronic device 115 may fit into the user's mouth to stimulate the user's tongue, while the pipe 113 may deliver a tasty substance. There may be a chemical dispersal actuator, not shown, for creating scents to the user 103.

In embodiments, a set of stimulations may have a desired chemical sense response for the user 103. However, in reality, the set of stimulations may generate an actual chemical sense response by the user 103 different from the desired chemical sense response. The actual chemical sense response by the user 103, or the desired chemical sense response for the user 103, may include a user response to a taste, a user response to a smell, a user response to a flavor, or a user response to a scent. The actual chemical sense response by the user 103 may be represented by data about response of the user 103 to the set of stimulations. The data about the user's response to a set of stimulations may include data about a facial expression of the user 103, data about a voice response or an utterance of the user 103, data about air flow in the user's nose, data about tongue muscle of the user 103, data about brainwave of the user 103, data about pupil of the user, or data about body of the user 103.

In embodiments, the data about the user's response to a set of stimulations may be collected by the monitor logic, e.g., the camera 121 or the sensor 123. The sensor 123 may be selected from many kinds of sensors. For example, the sensor 123 may be an electroencephalogram (EEG) sensor, an electrocardiogram (ECG) sensor, an electromyogram (EMG) sensor, a mechanomyogram (MMG) sensor, an electrooculography (EOG) sensor, a galvanic skin response (GSR) sensor, or a magnetoencephalogram (MEG) sensor. The monitor logic may also include other components, e.g., a brain-computer interface (BCI), not shown.

In embodiments, there may be a variance between the actual chemical sense response by the user 103 with respect to the set of stimulations, and the desired chemical sense response for the user 103 with respect to the set of stimulations. A second set of stimulations may be determined based at least in part on the variance between the actual chemical sense response by the user with respect to the first set of stimulations, and the desired chemical sense response for the user with respect to the first set of stimulations. The distribution logic may deliver to the user 103 the second set of stimulations. The second set of stimulations may be different from the first set of stimulations, and the second set of stimulations may be determined by a stimulation determination algorithm based on machine learning. The second set of stimulations may be intended to generate an updated desired chemical sense response for the user. The updated desired chemical sense response for the user may be a stronger, a weaker, or a same chemical sense response compared to the desired chemical sense response for the user with respect to the first set of stimulations. In some embodiments, the updated desired chemical sense response for the user may block the desired chemical sense response for the user with respect to the first set of stimulations.

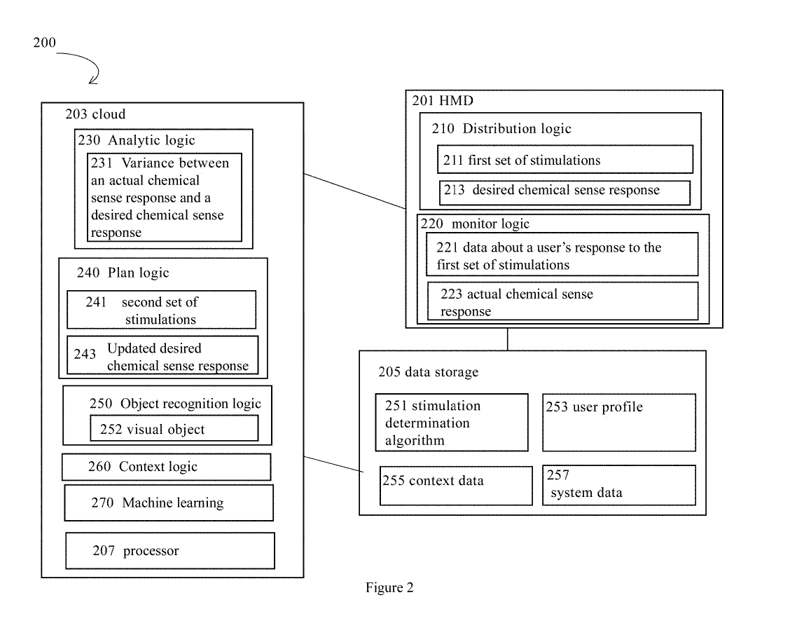

FIG. 2 illustrates an example apparatus 200 for MR with chemical sense response including various components such as distribution logic 210, monitor logic 220, analytic logic 230, plan logic 240, in accordance with various embodiments. In embodiments, the distribution logic 210 and the monitor logic 220 may be located on a HMD 201, similar to the situation where the monitor logic and the distribution logic located on the HMD 101, as shown in FIG. 1.

In embodiments, the apparatus 200 may include the HMD 201, a cloud component 203, and a data storage 205. The HMD 201 may include the distribution logic 210, and the monitor logic 220. The cloud component 203 may include the analytic logic 230, the plan logic 240, an object recognition logic 250, a context logic 260, and a machine-learning component 270. The cloud component 203 may further include a processor 207. The data storage 205 may include a stimulation determination algorithm 251, a user profile 253, context data 255, and system data 257.

In some embodiments, the analytic logic 230, the plan logic 240, the object recognition logic 250, the context logic 260, or the machine-learning component 270 may be located in the cloud component 203. In some other embodiments, the analytic logic 230, the plan logic 240, the object recognition logic 250, the context logic 260, or the machine-learning component 270 may be located in the HMD 201, or in a computing device attached to the HMD 201. In some embodiments, at least one of the analytic logic 230, the plan logic 240, the object recognition logic 250, the context logic 260, or the machine-learning component 270 may be implemented in software operated by the computer processor 207. The data storage 205 may be a part of the cloud component 203, a part of the HMD 201, an independent component, or split into multiple parts, some stored in the cloud component 203, and some other stored in the HMD 201.

In embodiments, the distribution logic 210 may be similar to the distribution logic shown in FIG. 1 including the chemical stimulation storage 111, the pipe 113, the electronic device 115, the audio generator 117, or the display 119, to deliver to a user a first set of stimulations 211. The first set of stimulations 211 may have a desired chemical sense response 213 for the user.

In embodiments, the monitor logic 220 may be similar to the monitor logic shown in FIG. 1 including the camera 121 and the sensor 123. The monitor logic 220 may collect data 221 about a user's response to the first set of stimulations 211, where the collected data 221 may represent an actual chemical sense response 223 by the user with respect to the first set of stimulations 211.

In embodiments, the analytic logic 230 may determine a variance 231 between the actual chemical sense response 223 by the user with respect to the first set of stimulations 211, and the desired chemical sense response 213 for the user with respect to the first set of stimulations 211. The plan logic 240 may determine a second set of stimulations 241, intended to generate an updated desired chemical sense response 243 for the user. The second set of stimulations 241 may be determined based at least in part on the variance 231 between the actual chemical sense response 223 by the user with respect to the first set of stimulations 211, and the desired chemical sense response 213 for the user with respect to the first set of stimulations 211. The second set of stimulations 241 may be determined by the stimulation determination algorithm 251, based on the user profile 253, the context data 255 for an environment of the user, the system data 257 related to the desired chemical sense response 213, or the collected data 221 about the user's response to the first set of stimulations 211.

In embodiments, the stimulation determination algorithm 251, the user profile 253, the context data 255 for an environment of the user, the system data 257 related to the desired chemical sense response 213, or the collected data 221 about the user's response to the first set of stimulations 211 may all or partly stored in the data storage 205. The user profile 253 may include a user's age, a user personal information, a user's background such as culture background, education, food preference, or other information related to the user's past experiences and history. The context data 255 may include data for the environment of the user includes a time, or a location of the user, which may be determined by the context logic 260. The system data 257 may be related to the desired chemical sense response include data gathered from multiple other users, which may be gained by the machine learning 270.

In some embodiments, the updated desired chemical sense response 243 may be a stronger, a weaker, or a same chemical sense response compared to the desired chemical sense response 213 for the user with respect to the first set of stimulations 211. For example, the updated desired chemical sense response 243 for the user may be the same as the desired chemical sense response 213 for the user with respect to the first set of stimulations 211, the second set of stimulations 241 may be different from the first set of stimulations 211, and the second set of stimulations 241 may be determined by the stimulation determination algorithm 251 based on machine learning 270. In some other embodiments, the updated desired chemical sense response 243 for the user may block the desired chemical sense response 213 for the user with respect to the first set of stimulations 211.

In embodiments, the object recognition logic 250 may recognize a visual object 252 in a visual field, or an action of the user. Accordingly, the plan logic 240 may further determine a set of stimulations intended to generate a chemical sense response corresponding to the visual object 252 or the user action.

In embodiments, the distribution logic 210 and the monitor logic 220 of HMD 201 may be implemented in hardware and/or software. Examples of hardware implementations may include ASIC or programmable circuit (such as FPGA). Software implementations may include processor, memory, and executable code/instructions. Executable code/instructions may be compiled from any one of a number of high level languages.

For the illustrated embodiments where cloud 203 may include the processor 207, the analytic logic 230, the plan logic 240, the object recognition logic 250, the context logic 260, and the machine-learning component 270 may be implemented in software, which may include codes/instructions executable by the processor 207. The executable codes/instructions may be compiled from any one of a number of high level languages. In some embodiments, selected ones of the analytic logic 230, the plan logic 240, the object recognition logic 250, the context logic 260, and the machine-learning component 270 may be implemented in hardware, such as ASIC or programmable circuits (like FPGA). In some embodiments, the programmable circuits may be part of processor 207.

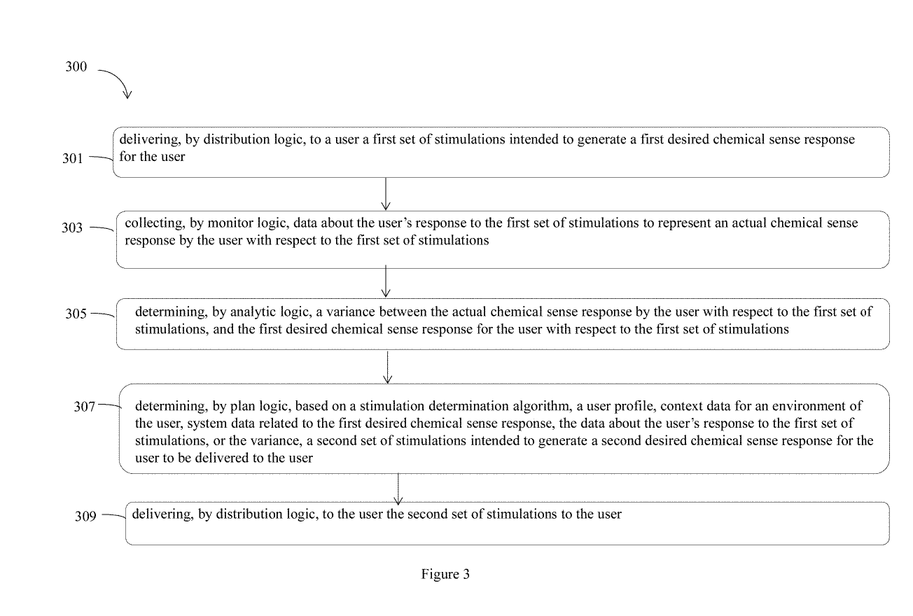

FIG. 3 illustrates an example process 300 for determining a second set of stimulations to be delivered to a user based on data about the user's response to a first set of stimulations, in accordance with various embodiments. In embodiments, the process 300 may be performed by the apparatus 200 shown in FIG. 2 to determine the second set of stimulations 241 to be delivered to a user based on collected data 221 about the user's response to the first set of stimulations 211. The first set of stimulations 211 or the second set of stimulations 241 may be delivered by the distribution logic 210, including circuitry, which may be similar to the distribution logic shown in FIG. 1 including the chemical stimulation storage 111, the pipe 113, the electronic device 115, the audio generator 117, or the display 119.

The process 300 may start at an interaction 301. During the interaction 301, a first set of stimulations may be delivered, by distribution logic, to a user. The first set of stimulations may intend to generate a first desired chemical sense response for the user. For example, at the interaction 301, the first set of stimulations 211 may be delivered to a user by the distribution logic 210. The first set of stimulations 211 may intend to generate the first desired chemical sense response 213 for the user.

During an interaction 303, data about the user's response to the first set of stimulations may be collected, by monitor logic, to represent an actual chemical sense response by the user with respect to the first set of stimulations. For example, at the interaction 303, the data 221 about the user's response to the first set of stimulations 211 may be collected, by the monitor logic 220, to represent an actual chemical sense response 223 by the user with respect to the first set of stimulations 211.

During an interaction 305, a variance may be determined, by analytic logic, between the actual chemical sense response by the user with respect to the first set of stimulations, and the first desired chemical sense response for the user with respect to the first set of stimulations. For example, at the interaction 305, the variance 231 may be determined, by the analytic logic 230, between the actual chemical sense response 223 by the user with respect to the first set of stimulations 211, and the first desired chemical sense response 213 for the user with respect to the first set of stimulations 211.

During an interaction 307, a second set of stimulations may be determined, by plan logic, intended to generate a second desired chemical sense response for the user. The second set of stimulations may be determined based on a stimulation determination algorithm, a user profile, context data for an environment of the user, system data related to the first desired chemical sense response, the data about the user's response to the first set of stimulations, or the variance. For example, at the interaction 307, the second set of stimulations 241 may be determined, by the plan logic 240, intended to generate the updated desired chemical sense response 243 for the user. The second set of stimulations 241 may be determined based on the stimulation determination algorithm 251, the user profile 253, the context data 255 for an environment of the user, the system data 257 related to the first desired chemical sense response, the data 221 about the user's response to the first set of stimulations, or the variance 231.

During an interaction 309, the second set of stimulations may be delivered, by the distribution logic, to the user. For example, at the interaction 309, the second set of stimulations 241 may be delivered, by the distribution logic 210, to the user. Afterwards, similar to the interaction 303, the monitor logic 220 may collect the data about the user's response to the second set of stimulations 241 to represent an actual chemical sense response by the user with respect to the second set of stimulations 241. The process 300 may continue the interactions of the process 300 for the second set of stimulations 241, until the process 300 decides to stop, e.g., when a variance between an actual chemical sense response by the user with respect to a set of stimulations, and the desired chemical sense response for the user with respect to the set of stimulations becomes below a performance threshold.

In some embodiments, the various interactions, e.g., the interaction 301, the interaction 303, the interaction 305, the interaction 307, and the interaction 309, may be ordered as shown in FIG. 3. In some other embodiments, various interactions of the process 300 may be performed in an order different from the one shown in FIG. 3.

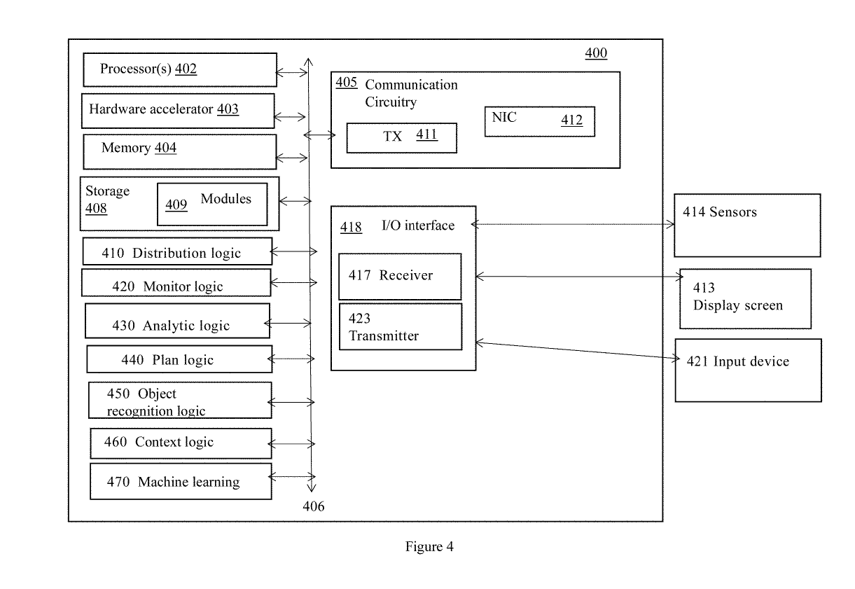

FIG. 4 illustrates an example device 400 suitable for use to practice various aspects of the present disclosure, in accordance with various embodiments. The device 400 may be used to implement various ones of the functions of the apparatus 100, the apparatus 200, or the process 300. As shown, the device 400 may include one or more processors 402, each having one or more processor cores, or and optionally, a hardware accelerator 403 (which may be a FPGA). In alternate embodiments, the hardware accelerator 403 may be part of processor 402, or integrated together on a SOC. Additionally, the device 400 may include a memory 404, which may be any one of a number of known persistent storage medium, and a data storage circuitry 408 including modules 409. In addition, the 400 may include an I/O interface 418 having a transmitter 423 and a receiver 417, and coupled to one or more sensors 414, a display screen 413, and an input device 421. Furthermore, the device 400 may include communication circuitry 405 including a transceiver (Tx) 411, and network interface controller (NIC) 412. The elements may be coupled to each other via system bus 406, which may represent one or more buses. In the case of multiple buses, they may be bridged by one or more bus bridges (not shown).

In addition, the device 400 may include distribution logic 410, monitor logic 420, analytic logic 430, plan logic 440, object recognition logic 450, context logic 460, and machine-learning component 470. In some embodiments, the distribution logic 410, the monitor logic 420, the analytic logic 430, the plan logic 440, the object recognition logic 450, the context logic 460, and the machine-learning component 470, may be similar to the distribution logic 210, the monitor logic 220, the analytic logic 230, the plan logic 240, the object recognition logic 250, the context logic 260, and the machine-learning component 270, as shown in FIG. 2, or other similar components shown in FIG. 1. As described earlier, distribution logic 410, monitor logic 420, analytic logic 430, plan logic 440, object recognition logic 450, context logic 460, and machine-learning component 470 may be implemented as ASIC or programmable circuit (such as FPGA) coupled to the processor 402 and the hardware accelerator 403 via bus(es) 460. In alternate embodiments, selected ones of distribution logic 410, monitor logic 420, analytic logic 430, plan logic 440, object recognition logic 450, context logic 460, and machine-learning component 470 may be implemented as firmware that operates within hardware accelerator, or software (such as modules 409) executed by processor 402 instead. Further, the sensors 414 and the storage 408, may be similar to the sensor 123 in FIG. 1, and the data storage 205 in FIG. 2.

In embodiments, the processor(s) 402 (also referred to as “processor circuitry 402”) may be one or more processing elements configured to perform basic arithmetical, logical, and input/output operations by carrying out instructions. Processor circuitry 402 may be implemented as a standalone system/device/package or as part of an existing system/device/package. The processor circuitry 402 may be one or more microprocessors, one or more single-core processors, one or more multi-core processors, one or more multithreaded processors, one or more GPUs, one or more ultra-low voltage processors, one or more embedded processors, one or more DSPs, one or more FPDs (hardware accelerators) such as FPGAs, structured ASICs, programmable SoCs (PSoCs), etc., and/or other processor or processing/controlling circuit. The processor circuitry 402 may be a part of a SoC in which the processor circuitry 402 and other components discussed herein are formed into a single IC or a single package. As examples, the processor circuitry 402 may include one or more Intel Pentium®, Core®, Xeon®, Atom®, or Core M® processor(s); Advanced Micro Devices (AMD) Accelerated Processing Units (APUs), Epyc®, or Ryzen® processors; Apple Inc. A series, S series, W series, etc. processor(s); Qualcomm snapdragon® processor(s); Samsung Exynos® processor(s); and/or the like.

In embodiments, the processor circuitry 402 may include a sensor hub, which may act as a coprocessor by processing data obtained from the one or more sensors 414. The sensor hub may include circuitry configured to integrate data obtained from each of the one or more sensors 414 by performing arithmetical, logical, and input/output operations. In embodiments, the sensor hub may capable of timestamping obtained sensor data, providing sensor data to the processor circuitry 402 in response to a query for such data, buffering sensor data, continuously streaming sensor data to the processor circuitry 402 including independent streams for each sensor of the one or more sensors 414, reporting sensor data based upon predefined thresholds or conditions/triggers, and/or other like data processing functions.

In embodiments, the memory 404 (also referred to as “memory circuitry 404” or the like) may be circuitry configured to store data or logic for operating the computer device 400. The memory circuitry 404 may include number of memory devices may be used to provide for a given amount of system memory. As examples, the memory circuitry 404 can be any suitable type, number and/or combination of volatile memory devices (e.g., random access memory (RAM), dynamic RAM (DRAM), static RAM (SAM), etc.) and/or non-volatile memory devices (e.g., read-only memory (ROM), erasable programmable read-only memory (EPROM), electrically erasable programmable read-only memory (EEPROM), flash memory, antifuses, etc.) that may be configured in any suitable implementation as are known. In various implementations, individual memory devices may be formed of any number of different package types, such as single die package (SDP), dual die package (DDP) or quad die package (Q17P), dual inline memory modules (DIMMs) such as microDIMMs or MiniDIMMs, and/or any other like memory devices. To provide for persistent storage of information such as data, applications, operating systems and so forth, the memory circuitry 404 may include one or more mass-storage devices, such as a solid state disk drive (SSDD); flash memory cards, such as SD cards, microSD cards, xD picture cards, and the like, and USB flash drives; on-die memory or registers associated with the processor circuitry 402 (for example, in low power implementations); a micro hard disk drive (HDD); three dimensional cross-point (3D)(POINT) memories from Intel® and Micron®, etc.

Where FPDs are used, the processor circuitry 402 and memory circuitry 404 (and/or data storage circuitry 408) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry 402 to implement various logic functions. The memory cells may include any combination of various levels of memory/storage including, but not limited to, EPROM, EEPROM, flash memory, SRAM, anti-fuses, etc.

In embodiments, the data storage circuitry 408 (also referred to as “storage circuitry 408” or the like), with shared or respective controllers, may provide for persistent storage of information such as modules 409, operating systems, etc. The data storage circuitry 408 may be implemented as solid state drives (SSDs); solid state disk drive (SSDD); serial AT attachment (SATA) storage devices (e.g., SATA SSDs); flash drives; flash memory cards, such as SD cards, microSD cards, xD picture cards, and the like, and USB flash drives; three-dimensional cross-point (3D Xpoint) memory devices; on-die memory or registers associated with the processor circuitry 402; hard disk drives (HDDs); micro HDDs; resistance change memories; phase change memories; holographic memories; or chemical memories; among others. As shown, the data storage circuitry 408 is included in the computer device 400; however, in other embodiments, the data storage circuitry 408 may be implemented as one or more devices separated from the other elements of computer device 400.

In some embodiments, the data storage circuitry 408 may include an operating system (OS) (not shown), which may be a general purpose operating system or an operating system specifically written for and tailored to the computer device 400. The OS may include one or more drivers, libraries, and/or application programming interfaces (APIs), which provide program code and/or software components for modules 409 and/or control system configurations to control and/or obtain/process data from the one or more sensors 414.

The components of computer device 400 may communicate with one another over the bus 406. The bus 406 may include any number of technologies, such as a Local Interconnect Network (LIN); industry standard architecture (ISA); extended ISA (EISA); PCI; PCI extended (PCIx); PCIe; an Inter-Integrated Circuit (I2C) bus; a Parallel Small Computer System Interface (SPI) bus; Common Application Programming Interface (CAPI); point to point interfaces; a power bus; a proprietary bus, for example, Intel® Ultra Path Interface (UPI), Intel® Accelerator Link (IAL), or some other proprietary bus used in a SoC based interface; or any number of other technologies. In some embodiments, the bus 406 may be a controller area network (CAN) bus system, a Time-Trigger Protocol (TTP) system, or a FlexRay system, which may allow various devices (e.g., the one or more sensors 414, etc.) to communicate with one another using messages or frames.

The communications circuitry 405 may include circuitry for communicating with a wireless network or wired network. For example, the communication circuitry 405 may include transceiver (Tx) 411 and network interface controller (NIC) 412. Communications circuitry 405 may include one or more processors (e.g., baseband processors, modems, etc.) that are dedicated to a particular wireless communication protocol.

NIC 412 may be included to provide a wired communication link to a network and/or other devices. The wired communication may provide an Ethernet connection, an Ethernet-over-USB, and/or the like, or may be based on other types of networks, such as DeviceNet, ControlNet, Data Highway+, PROFIBUS, or PROFINET, among many others. An additional NIC 412 may be included to allow connect to a second network (not shown) or other devices, for example, a first NIC 412 providing communications to the network 150 over Ethernet, and a second NIC 412 providing communications to other devices over another type of network, such as a personal area network (PAN) including a personal computer (PC) device. In some embodiments, the various components of the device 400, such as the one or more sensors 414, etc. may be connected to the processor(s) 402 via the NIC 412 as discussed above rather than via the I/O circuitry 418 as discussed infra.

The Tx 411 may include one or more radios to wirelessly communicate with a network and/or other devices. The Tx 411 may include hardware devices that enable communication with wired networks and/or other devices using modulated electromagnetic radiation through a solid or non-solid medium. Such hardware devices may include switches, filters, amplifiers, antenna elements, and the like to facilitate the communications over the air (OTA) by generating or otherwise producing radio waves to transmit data to one or more other devices, and converting received signals into usable information, such as digital data, which may be provided to one or more other components of computer device 400. In some embodiments, the various components of the device 400, such as the one or more sensors 414, etc. may be connected to the device 400 via the Tx 411 as discussed above rather than via the I/O circuitry 418 as discussed infra. In one example, the one or more sensors 414 may be coupled with device 400 via a short range communication protocol.

The Tx411 may include one or multiple radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), and Fifth Generation (5G) New Radio (NR). It can be noted that radios compatible with any number of other fixed, mobile, or satellite communication technologies and standards may be selected. These may include, for example, any Cellular Wide Area radio communication technology, which may include e.g. a 5G communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System—Time-Division Duplex), TD-CDMA (Time Division—Code Division Multiple Access), TD-SCDMA (Time Division—Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated. Implementations, components, and details of the aforementioned protocols may be those known in the art and are omitted herein for the sake of brevity.

The input/output (I/O) interface 418 may include circuitry, such as an external expansion bus (e.g., Universal Serial Bus (USB), FireWire, Thunderbolt, PCl/PCIe/PCIx, etc.), used to connect computer device 400 with external components/devices, such as one or more sensors 414, etc. I/O interface circuitry 418 may include any suitable interface controllers and connectors to interconnect one or more of the processor circuitry 402, memory circuitry 404, data storage circuitry 408, communication circuitry 405, and the other components of computer device 400. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., bus 406), ports, slots, jumpers, interconnect modules, receptacles, modular connectors, etc. The I/O circuitry 418 may couple the device 400 with the one or more sensors 414, etc. via a wired connection, such as using USB, FireWire, Thunderbolt, RCA, a video graphics array (VGA), a digital visual interface (DVI) and/or mini-DVI, a high-definition multimedia interface (HDMI), an S-Video, and/or the like.

The one or more sensors 414 may be any device configured to detect events or environmental changes, convert the detected events into electrical signals and/or digital data, and transmit/send the signals/data to the computer device 400. Some of the one or more sensors 414 may be sensors used for providing computer-generated sensory inputs. Some of the one or more sensors 414 may be sensors used for motion and/or object detection. Examples of such one or more sensors 414 may include, inter alia, charged-coupled devices (CCD), Complementary metal-oxide-semiconductor (CMOS) active pixel sensors (APS), lens-less image capture devices/cameras, thermographic (infrared) cameras, Light Imaging Detection And Ranging (LIDAR) systems, and/or the like. In some implementations, the one or more sensors 414 may include a lens-less image capture mechanism comprising an array of aperture elements, wherein light passing through the array of aperture elements define the pixels of an image. In embodiments, the motion detection one or more sensors 414 may be coupled with or associated with light generating devices, for example, one or more infrared projectors to project a grid of infrared light onto a scene, where an infrared camera may record reflected infrared light to compute depth information.

Some of the one or more sensors 414 may be used for position and/or orientation detection, ambient/environmental condition detection, and the like. Examples of such one or more sensors 414 may include, inter alia, microelectromechanical systems (MEMS) with piezoelectric, piezoresistive and/or capacitive components, which may be used to determine environmental conditions or location information related to the computer device 400. In embodiments, the MEMS may include 3-axis accelerometers, 3-axis gyroscopes, and/or magnetometers. In some embodiments, the one or more sensors 414 may also include one or more gravimeters, altimeters, barometers, proximity sensors (e.g., infrared radiation detector(s) and the like), depth sensors, ambient light sensors, thermal sensors (thermometers), ultrasonic transceivers, and/or the like.

Each of these elements, e.g., one or more processors 402, the hardware accelerator 403, the memory 404, the data storage circuitry 408 including the modules 409, the input/output interface 418, the one or more sensors 414, the communication circuitry 405 including the Tx 411, and the NIC 412, and the system bus 406, may perform its conventional functions known in the art. In addition, they may be employed to store and host execution of programming instructions implementing the operations associated with operations to be performed by an apparatus for computer assisted or autonomous driving, as described in connection with FIGS. 1-3, and/or other functions that provides the capability of the embodiments described in the current disclosure. The various elements may be implemented by assembler instructions supported by processor(s) 402 or high-level languages, such as, for example, C, that can be compiled into such instructions. Operations associated with the device 400 not implemented in software may be implemented in hardware, e.g., via hardware accelerator 403.

The number, capability and/or capacity of these elements 402-470 may vary, depending on the number of other devices the device 400 is configured to support. Otherwise, the constitutions of elements 402-470 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

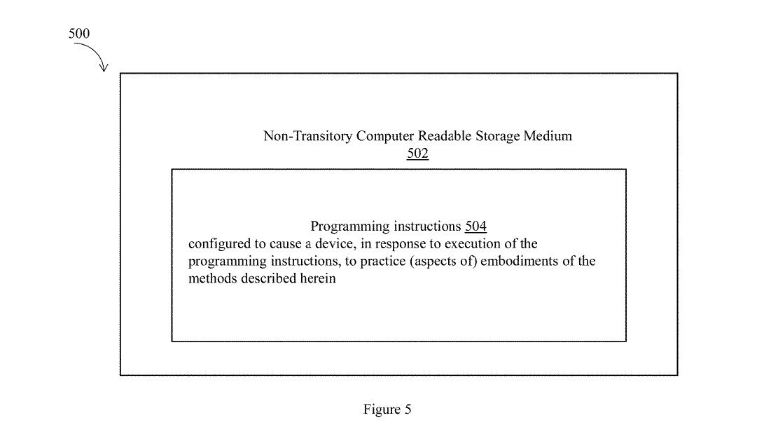

Furthermore, the present disclosure may take the form of a computer program product embodied in any tangible or non-transitory medium of expression having computer-usable program code embodied in the medium. FIG. 5 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 502 may include a number of programming instructions 504. Programming instructions 504 may be configured to enable a device, e.g., device 500, in response to execution of the programming instructions, to perform, e.g., various operations associated with an apparatus for determining a second set of stimulations to be delivered to a user for chemical sense response based on data about the user's response to a first set of stimulations, as shown in FIGS. 1-4.

In alternate embodiments, programming instructions 504 may be disposed on multiple computer-readable non-transitory storage media 502 instead. In alternate embodiments, programming instructions 504 may be disposed on computer-readable transitory storage media 502, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseb and or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may include an apparatus for a mixed, augmented, or virtual reality computing with chemical sense response, comprising: monitor logic to collect data about a user's response to a first set of stimulations to represent an actual chemical sense response by the user with respect to the first set of stimulations, wherein the collected data are used to determine a variance between the actual chemical sense response by the user with respect to the first set of stimulations, and a desired chemical sense response for the user with respect to the first set of stimulations; and distribution logic coupled to the monitor logic, including circuitry, to deliver to the user a second set of stimulations, wherein the second set of stimulations are determined based at least in part on the variance between the actual chemical sense response by the user with respect to the first set of stimulations, and the desired chemical sense response for the user with respect to the first set of stimulations.

Example 2 may include the apparatus of example 1 and/or some other examples herein, wherein the first set of stimulations or the second set of stimulations includes one or more of an electrical stimulation, a chemical stimulation, a visual stimulation, or an audio stimulation.

Example 3 may include the apparatus of example 1 and/or some other examples herein, wherein the data about the user's response to the first set of stimulations include data about a facial expression of the user, data about a voice response or an utterance of the user, data about air flow in the user's nose, data about tongue muscle of the user, data about brainwave of the user, data about pupil of the user, or data about body of the user.

Example 4 may include the apparatus of example 1 and/or some other examples herein, wherein the actual chemical sense response by the user, or the desired chemical sense response for the user includes a user response to a taste, a user response to a smell, a user response to a flavor, or a user response to a scent.

Example 5 may include the apparatus of example 1 and/or some other examples herein, wherein the monitor logic includes a camera, a brain-computer interface (BCI), an electroencephalogram (EEG) sensor, an electrocardiogram (ECG) sensor, an electromyogram (EMG) sensor, a mechanomyogram (MMG) sensor, an electrooculography (EOG) sensor, a galvanic skin response (GSR) sensor, or a magnetoencephalogram (MEG) sensor.

Example 6 may include the apparatus of example 1 and/or some other examples herein, wherein the distribution logic includes an electronic device that fits into the user's mouth to stimulate the user's tongue, a pipe to deliver a tasty substance, a chemical dispersal actuator for creating scents, a display for visual content, or an audio generator.

Example 7 may include the apparatus of example 1 and/or some other examples herein, wherein the monitor logic or the distribution logic is located on a head-mounted device (HMD).

Example 8 may include the apparatus of example 1 and/or some other examples herein, further comprising: analytic logic to determine the variance between the actual chemical sense response by the user with respect to the first set of stimulations, and the desired chemical sense response for the user with respect to the first set of stimulations; and plan logic to determine, by a stimulation determination algorithm, based on a user profile, context data for an environment of the user, system data related to the desired chemical sense response, or the data about the user's response to the first set of stimulations, the second set of stimulations intended to generate an updated desired chemical sense response for the user.

Example 9 may include the apparatus of example 8 and/or some other examples herein, wherein the analytic logic and the plan logic are located in a cloud-based server, or a head-mounted device (HMD).

Example 10 may include the apparatus of example 8 and/or some other examples herein, wherein the updated desired chemical sense response for the user is a stronger, a weaker, or a same chemical sense response compared to the desired chemical sense response for the user with respect to the first set of stimulations, or the updated desired chemical sense response for the user is to block the desired chemical sense response for the user with respect to the first set of stimulations.

Example 11 may include the apparatus of example 8 and/or some other examples herein, wherein the updated desired chemical sense response for the user is same as the desired chemical sense response for the user with respect to the first set of stimulations, the second set of stimulations is different from the first set of stimulations, and the second set of stimulations is determined by the stimulation determination algorithm based on machine learning.

Example 12 may include the apparatus of example 8 and/or some other examples herein, further comprises a data storage to store the stimulation determination algorithm, the user profile, and the system data related to the desired chemical sense response.

Example 13 may include the apparatus of example 8 and/or some other examples herein, wherein the user profile includes a user's age, a user personal information, and the context data for the environment of the user includes a time, or a location of the user.

Example 14 may include the apparatus of example 8 and/or some other examples herein, wherein the system data related to the desired chemical sense response include data gathered from multiple other users.

Example 15 may include the apparatus of example 8 and/or some other examples herein, further comprising: object recognition logic to recognize a visual object in a visual field, or an action of the user, wherein the plan logic is further to determine a set of stimulations intended to generate a chemical sense response corresponding to the visual object or the user action.

Example 16 may include the apparatus of example 15 and/or some other examples herein, further comprising a computer processor, wherein at least one of the monitor logic, the analytic logic, the plan logic, and the object recognition logic is implemented in software operated by the computer processor.

Example 17 may include one or more non-transitory computer-readable media comprising instructions for mixed, augmented, or virtual reality computing with chemical sense response that cause a computer device, in response to execution of the instructions by the computer device, to operate the computer device to: determine a variance between an actual chemical sense response by a user with respect to a first set of stimulations, and a desired chemical sense response for the user with respect to the first set of stimulations, wherein the actual chemical sense response by the user is represented by data about the user's response to the first set of stimulations, and the first set of stimulations includes one or more of an electrical stimulation, a chemical stimulation, a visual stimulation, or an audio stimulation; and determine, by a stimulation determination algorithm, based on a user profile, context data for an environment of the user, system data related to the first desired chemical sense response, or the data about the user's response to the first set of stimulations, a second set of stimulations intended to generate an updated desired chemical sense response for the user, wherein the second set of stimulations includes one or more of an electrical stimulation, a chemical stimulation, a visual stimulation, or an audio stimulation to be delivered to the user.

Example 18 may include the one or more non-transitory computer-readable media of example 17 and/or some other examples herein, in response to execution of the instructions by the computer device, to operate the computer device further to: collect the data about the user's response to the first set of stimulations.

Example 19 may include the one or more non-transitory computer-readable media of example 17 and/or some other examples herein, in response to execution of the instructions by the computer device, to operate the computer device further to: deliver to the user the second set of stimulations.

Example 20 may include the one or more non-transitory computer-readable media of example 17 and/or some other examples herein, in response to execution of the instructions by the computer device, to operate the computer device further to: update, based on the data about the user's response to the first set of stimulations, the user profile or the system data related to the desired chemical sense response.

Example 21 may include a method for operating an apparatus for mixed, augmented, or virtual reality with chemical sense response, comprising: delivering, by distribution logic, to a user a first set of stimulations intended to generate a first desired chemical sense response for the user; collecting, by monitor logic, data about the user's response to the first set of stimulations to represent an actual chemical sense response by the user with respect to the first set of stimulations; determining, by analytic logic, a variance between the actual chemical sense response by the user with respect to the first set of stimulations, and the first desired chemical sense response for the user with respect to the first set of stimulations; and determining, by plan logic, based on a stimulation determination algorithm, a user profile, context data for an environment of the user, system data related to the first desired chemical sense response, the data about the user's response to the first set of stimulations, or the variance, a second set of stimulations intended to generate a second desired chemical sense response for the user to be delivered to the user; wherein the first set of stimulations or the second set of stimulations includes one or more of an electrical stimulation, a chemical stimulation, a visual stimulation, or an audio stimulation.

Example 22 may include the method of example 21 and/or some other examples herein, wherein the monitor logic includes a camera, a brain-computer interface (BCI), an electroencephalogram (EEG) sensor, an electrocardiogram (ECG) sensor, an electromyogram (EMG) sensor, a mechanomyogram (MMG) sensor, an electrooculography (EOG) sensor, a galvanic skin response (GSR) sensor, or a magnetoencephalogram (MEG) sensor.

Example 23 may include the method of example 21 and/or some other examples herein, wherein the distribution logic includes an electronic device that fits into the user's mouth to stimulate the user's tongue, a pipe to deliver a tasty substance, a chemical dispersal actuator for creating scents, a display for visual content, or an audio generator.

Example 24 may include the method of example 21 and/or some other examples herein, wherein the analytic logic and the plan logic are located in a cloud-based server, in a head-mounted device (HMD), or in a computing device attached to a HMD.

Example 25 may include the method of example 21 and/or some other examples herein, wherein the data about the user's response to the set of stimulations include data about a facial expression of the user, data about a voice response or an utterance of the user, data about air flow in the user's nose, data about tongue muscle of the user, data about brainwave of the user, data about pupil of the user, or data about body of the user.

Although certain embodiments have been illustrated and described herein for purposes of description this application is intended to cover any adaptations or variations of the embodiments discussed herein. Therefore, it is manifestly intended that embodiments described herein be limited only by the claims.

What is claimed is:

1. An apparatus for a mixed, augmented, or virtual reality computing with chemical sense response, comprising:
monitor logic to collect data about a user's response to a first set of stimulations to represent an actual chemical sense response by the user with respect to the first set of stimulations, wherein the collected data are used to determine a variance between the actual chemical sense response by the user with respect to the first set of stimulations, and a desired chemical sense response for the user with respect to the first set of stimulations; and
distribution logic coupled to the monitor logic, including circuitry, to deliver to the user a second set of stimulations, wherein the second set of stimulations are determined based at least in part on the variance between the actual chemical sense response by the user with respect to the first set of stimulations, and the desired chemical sense response for the user with respect to the first set of stimulations.

2. The apparatus of claim 1, wherein the first set of stimulations or the second set of stimulations includes one or more of an electrical stimulation, a chemical stimulation, a visual stimulation, or an audio stimulation.

3. The apparatus of claim 1, wherein the data about the user's response to the first set of stimulations include data about a facial expression of the user, data about a voice response or an utterance of the user, data about air flow in the user's nose, data about tongue muscle of the user, data about brainwave of the user, data about pupil of the user, or data about body of the user.

4. The apparatus of claim 1, wherein the actual chemical sense response by the user, or the desired chemical sense response for the user includes a user response to a taste, a user response to a smell, a user response to a flavor, or a user response to a scent.

5. The apparatus of claim 1, wherein the monitor logic includes a camera, a brain-computer interface (BCI), an electroencephalogram (EEG) sensor, an electrocardiogram (ECG) sensor, an electromyogram (EMG) sensor, a mechanomyogram (MMG) sensor, an electrooculography (EOG) sensor, a galvanic skin response (GSR) sensor, or a magnetoencephalogram (MEG) sensor.

6. The apparatus of claim 1, wherein the distribution logic includes an electronic device that fits into the user's mouth to stimulate the user's tongue, a pipe to deliver a tasty substance, a chemical dispersal actuator for creating scents, a display for visual content, or an audio generator.

7. The apparatus of claim 1, wherein the monitor logic or the distribution logic is located on a head-mounted device (HMD).

8. The apparatus of claim 1, further comprising:
analytic logic to determine the variance between the actual chemical sense response by the user with respect to the first set of stimulations, and the desired chemical sense response for the user with respect to the first set of stimulations; and
plan logic to determine, by a stimulation determination algorithm, based on a user profile, context data for an environment of the user, system data related to the desired chemical sense response, or the data about the user's response to the first set of stimulations, the second set of stimulations intended to generate an updated desired chemical sense response for the user.

9. The apparatus of claim 8, wherein the analytic logic and the plan logic are located in a cloud-based server, or a head-mounted device (HMD).

10. The apparatus of claim 8, wherein the updated desired chemical sense response for the user is a stronger, a weaker, or a same chemical sense response compared to the desired chemical sense response for the user with respect to the first set of stimulations, or the updated desired chemical sense response for the user is to block the desired chemical sense response for the user with respect to the first set of stimulations.

11. The apparatus of claim 8, wherein the updated desired chemical sense response for the user is same as the desired chemical sense response for the user with respect to the first set of stimulations, the second set of stimulations is different from the first set of stimulations, and the second set of stimulations is determined by the stimulation determination algorithm based on machine learning.

12. The apparatus of claim 8, further comprises a data storage to store the stimulation determination algorithm, the user profile, and the system data related to the desired chemical sense response.

13. The apparatus of claim 8, wherein the user profile includes a user's age, a user personal information, and the context data for the environment of the user includes a time, or a location of the user.

14. The apparatus of claim 8, wherein the system data related to the desired chemical sense response include data gathered from multiple other users.

15. The apparatus of claim 8, further comprising:
object recognition logic to recognize a visual object in a visual field, or an action of the user, wherein the plan logic is further to determine a set of stimulations intended to generate a chemical sense response corresponding to the visual object or the user action.

16. The apparatus of claim 15, further comprising a computer processor, wherein at least one of the monitor logic, the analytic logic, the plan logic, and the object recognition logic is implemented in software operated by the computer processor.

17. One or more non-transitory computer-readable media comprising instructions for mixed, augmented, or virtual reality computing with chemical sense response that cause a computer device, in response to execution of the instructions by the computer device, to operate the computer device to:
determine a variance between an actual chemical sense response by a user with respect to a first set of stimulations, and a desired chemical sense response for the user with respect to the first set of stimulations, wherein the actual chemical sense response by the user is represented by data about the user's response to the first set of stimulations, and the first set of stimulations includes one or more of an electrical stimulation, a chemical stimulation, a visual stimulation, or an audio stimulation; and
determine, by a stimulation determination algorithm, based on a user profile, context data for an environment of the user, system data related to the first desired chemical sense response, or the data about the user's response to the first set of stimulations, a second set of stimulations intended to generate an updated desired chemical sense response for the user, wherein the second set of stimulations includes one or more of an electrical stimulation, a chemical stimulation, a visual stimulation, or an audio stimulation to be delivered to the user.

18. The one or more non-transitory computer-readable media of claim 17, in response to execution of the instructions by the computer device, to operate the computer device further to:
collect the data about the user's response to the first set of stimulations.

19. The one or more non-transitory computer-readable media of claim 17, in response to execution of the instructions by the computer device, to operate the computer device further to:
deliver to the user the second set of stimulations.

20. The one or more non-transitory computer-readable media of claim 17, in response to execution of the instructions by the computer device, to operate the computer device further to:
update, based on the data about the user's response to the first set of stimulations, the user profile or the system data related to the desired chemical sense response.

21. A method for operating an apparatus for mixed, augmented, or virtual reality with chemical sense response, comprising:
delivering, by distribution logic, to a user a first set of stimulations intended to generate a first desired chemical sense response for the user;
collecting, by monitor logic, data about the user's response to the first set of stimulations to represent an actual chemical sense response by the user with respect to the first set of stimulations;
determining, by analytic logic, a variance between the actual chemical sense response by the user with respect to the first set of stimulations, and the first desired chemical sense response for the user with respect to the first set of stimulations; and
determining, by plan logic, based on a stimulation determination algorithm, a user profile, context data for an environment of the user, system data related to the first desired chemical sense response, the data about the user's response to the first set of stimulations, or the variance, a second set of stimulations intended to generate a second desired chemical sense response for the user to be delivered to the user;
wherein the first set of stimulations or the second set of stimulations includes one or more of an electrical stimulation, a chemical stimulation, a visual stimulation, or an audio stimulation.

22. The method of claim 21, wherein the monitor logic includes a camera, a brain-computer interface (BCI), an electroencephalogram (EEG) sensor, an electrocardiogram (ECG) sensor, an electromyogram (EMG) sensor, a mechanomyogram (MMG) sensor, an electrooculography (EOG) sensor, a galvanic skin response (GSR) sensor, or a magnetoencephalogram (MEG) sensor.

23. The method of claim 21, wherein the distribution logic includes an electronic device that fits into the user's mouth to stimulate the user's tongue, a pipe to deliver a tasty substance, a chemical dispersal actuator for creating scents, a display for visual content, or an audio generator.

24. The method of claim 21, wherein the analytic logic and the plan logic are located in a cloud-based server, in a head-mounted device (HMD), or in a computing device attached to a HMD.

25. The method of claim 21, wherein the data about the user's response to the set of stimulations include data about a facial expression of the user, data about a voice response or an utterance of the user, data about air flow in the user's nose, data about tongue muscle of the user, data about brainwave of the user, data about pupil of the user, or data about body of the user.
